(19) United States
(12) Patent Application Publication
(10) Pub. No.: US 2007/0247830 A1
(43) Pub. Date: Oct. 25, 2007

(54) SURFACE SUPPORTED LIGHTING MEDIA

(75) Inventors: Michael L. Schrimmer, Vernon Hills, IL (US); Ronald E. Gilley, Winnetka, IL (US)

Correspondence Address: LEVENFELD PEARLSTEIN;Intellectual Property Department, 2 North LaSalle, Suite 1300, CHICAGO, IL, 60602, US

(73) Assignee: Chemical Light, Inc., Vernon Hills, IL (US)

(21) Appl. No.: 11/379,341

(22) Filed: Apr. 19, 2006

(51) Int. Cl. F21V 9/16

(52) U.S. Cl. 362/84

(57) ABSTRACT

A surface supported lighting includes a chemiluminescent element and a reusable support element. The support element is configured for insertion into the surface in a desired orientation and includes a surface insertion spike and a stick receiving portion. The chemiluminescent element and the support element releasably engage one another to support the chemiluminescent element in the desired orientation when the support element is inserted into the surface. The chemiluminescent element can be disengaged from the support element for replacing the chemiluminescent element.

### BACKGROUND OF THE INVENTION

The present invention is directed to an illuminating device. More specifically, the present invention is directed to an illuminating device that permits the lighting of an area or pathway.

Outdoor illumination devices come in all manner, shape and size. Powered lighting is commercially available in alternating current (AC) and direct current (DC) types. Although powered lighting has the advantage of always being available, it requires that wire or cable be run from a power source to the light. This can be very expensive and, often, the lights cannot be readily moved once installed.

Other types of lighting are known, such as solar powered lamps. These lamps are limited in their use in that they can only be used after “charged” by the sun, or have a limited time to operate after being charged. Moreover, these lamps can be quite costly. This is particularly true when it is desired to illuminate a large area. Battery powered lamps are another alternative, however, the batteries would require frequent replacement (likely every day), which would also costly very quickly.

Along these lines, golf has become a very popular game. In fact, it has become so popular, that tee times are extending later and later into the afternoon and as such, games are often called due to darkness. Illuminated golf balls, of the chemiluminescent type and electrical type (e.g., LED-containing) have come into use. While these balls allow a player to locate a ball and continue play, they do not provide any general area illumination or lighting for foot traffic along the course.

Although “hard-wired” lighting would be ideal along a golf course, the length of many courses (in excess of 7000 yards) and the width of such courses, makes such a lighting installing cost prohibitive. Moreover, the cost for solar powered lighting is also cost prohibitive due to the large number of lamps that would have to be installed and replaced on a likely fairly consistent basis.

Accordingly, there is a need for a non-powered lighting device that can be placed as desired in any soft surface. Desirably, such a device is inexpensive and is readily replaceable. Most desirably, such a device can be actuated “as-needed”, in order to maximize usable life.

### BRIEF SUMMARY OF THE INVENTION

A surface supported lighting media includes a chemiluminescent element such as a light stick and a reusable support element. The support element is configured for insertion into a surface, for example, the ground, in a desired orientation. The support element includes a surface insertion spike and a stick receiving portion.

The present surface supported lighting media provides an inexpensive, non-powered lighting device that can be placed as desired in any penetratable surface, such as along a golf course. The light stick is readily replaceable and advantageously, can be actuated “as-needed”, in order to maximize usable life.

The light stick and the support element releasably engage one another to support the light stick in a desired orientation when the support element is inserted into the surface. The light stick can be disengaged from the support element for replacing the light stick.

In one form, the light stick includes an annular sleeve and the support element includes an insert portion configured for receipt in the sleeve. The support element can include an enlarged contact region, such as a flange at a location at which the light stick and the support element engage one another.

In an alternate embodiment, the support element includes a sleeve-like receiving element configured for receiving the light stick. The support element can include a contact region (e.g., a base) within the sleeve-like receiving element to provide a location at which the light stick and the support element engage one another. Optionally, the support element includes a retaining element to releasably secure the light stick element in the sleeve-like element.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of an embodiment of a surface supported lighting media embodying the principles of the present invention;

FIG. 2 is an exploded view of the lighting media of FIG. 1;

FIG. 3 is an exploded view of an alternate embodiment of the support portion; and

FIG. 4 is a top view of the embodiment of FIG. 3 showing a split diaphragm arrangement for accommodating different sized light elements.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

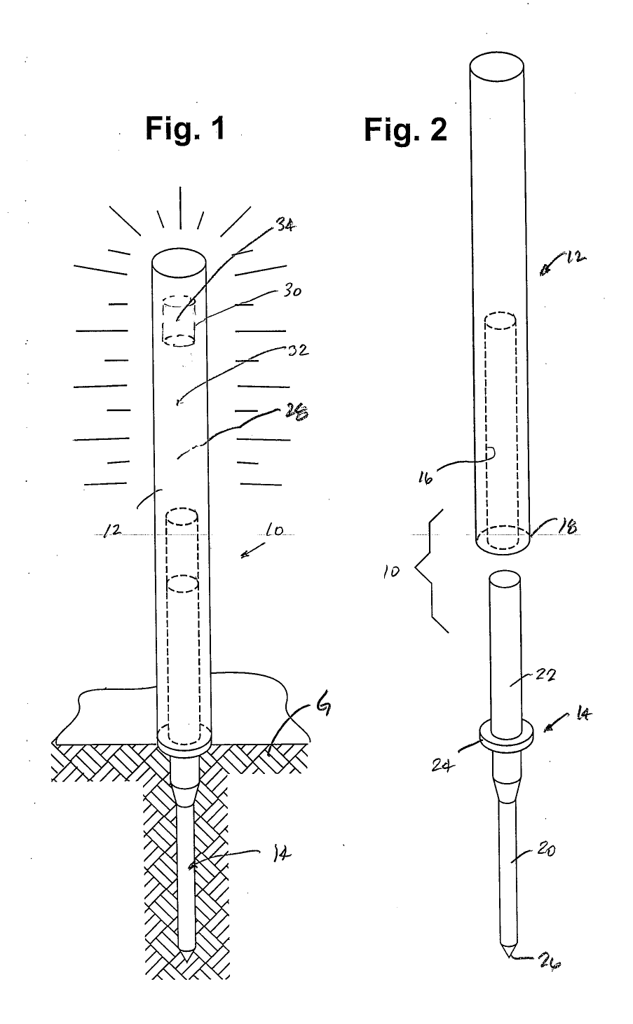

Referring now to the figures, and in particular to FIG. 1, there is shown an embodiment of a surface supported lighting media 10 embodying the principles of the present invention. The lighting media 10 includes an illuminating element 12, such as the illustrated chemiluminescent element (e.g., light stick) and a support element 14. The embodiment of the media 10 in FIG. 1 includes a light stick 12 having an annular sleeve 16 formed in an end 18 of the stick 12 that defines a socket or female portion of the stick 12. It is anticipated that the surface supported lighting media 10 will be used to, for example, illuminate the ground (e.g., a fairway or pathway) of a golf course, as a ground supported media. It will however be appreciated that the lighting media 10 can also be positioned in other surfaces, vertical as well as horizontal, to provide a cost effective, easily replaceable local lighting. The light stick 12 is supported in a desired orientation (e.g., vertical when in the ground and horizontal when in a wall or other vertical surface).

The support element 14 includes a spike portion 20 and an insert 22 that is received in socket portion 16 of the stick 12. A flange 24 is disposed at the juncture of the insert 22 and the spike 20. The spike 20 is preferably formed with a penetrating tip 26.

The chemiluminescent light stick 12 can be any of a number of commercially available light sticks. One preferred configuration of the light stick 12 has an outside chamber 28 and a breakable inside chamber 30 within the outside chamber. The outside chamber 28 contains a first chemical solution 32 and the internal chamber 30 contains a second solution 34 such that the internal chamber 30 is breakable by a user so that the solutions 32, 34 mix and react with one another to chemically drive the chemiluminescent light emission. In one known combination of solutions the first solution 32 contains a reductant compound and a fluorescent dye compound and the second solution 34 contains an oxidant compound and a solvent. One known oxidant is hydrogen peroxide, which can be used an oxalic phthalate reductant and water solvent. Exemplary fluorescent dye compounds are 9,10-diphenylanthracene, 9,10-bis(phenylethynyl)anthracene, and 5,6,11,12-tetraphenylnaphthacene. Other combinations of chemicals and methods/materials for providing the chemiluminescent effect will be recognized by those skilled in the art and are within the scope and spirit of the present invention.

In use, the support element insert 22 is inserted into the socket 16 of the light stick 12, the inside or internal chamber 30 in the light stick 12 is broken and the chemicals 32, 34 in the stick 12 are mixed to provide the chemiluminescent effect. The spike 20 (the media 10) is inserted as surface, for example into the ground G, and the light stick 12 is supported in a desired orientation. Advantageously, the flange 24 provides a relatively large surface at which the light stick 12 and support 14 contact one another and over which pressure is exerted on the light stick 12. This prevents over-stressing the light stick 12 at the socket 16, which could otherwise result in tearing the light stick 12 material.

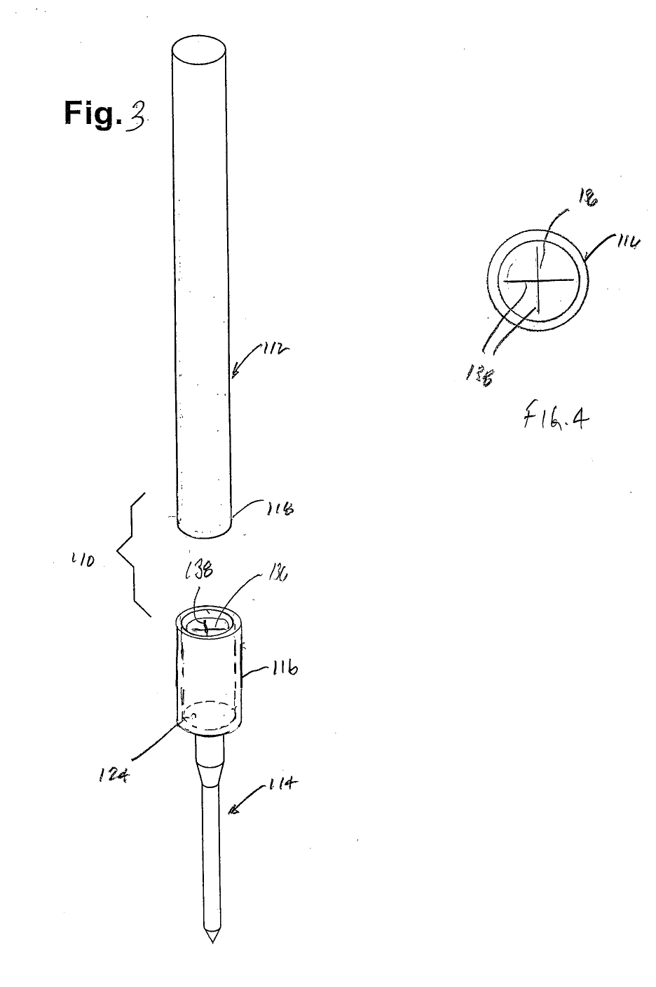

It will be appreciated that the embodiment 10 of FIGS. 1 and 2 requires the use of a light stick 12 having a socket or female portion 16 in order to engage the upright ground support 14. Accordingly, an alternate embodiment of the ground supported lighting media 110 is illustrated in FIGS. 3 and 4. In the alternate embodiment 110, the support element 114 includes a sleeve 116 into which the light stick 112 is inserted or fitted. In this manner, a conventional, non-socket-containing light stick 112 can be used to provide the ground supported media 110. The sleeve 116 extends upwardly only so far as to provide support for the light stick 112, without blocking or interfering with too large of a portion of the lower end 118 of the stick 112. The base 124 of the sleeve or cup 116 provides a sufficiently large area over which pressure is exerted when inserting the media 110 into the ground G, again, to prevent overstressing the light stick 112.

Optionally, the support 114 can include a gripping element 136 inside of the sleeve 116 that can permit the support portion 114 and sleeve 116 to accommodate light sticks 112 of various diameters. The gripping element 136 can, for example, be formed by a thin, flexible inwardly extending membrane that is slit or cut radially (as at 138), or discrete, elongated “fingers” (not shown) that extend inwardly to engage the sides of the light stick 112 when the stick 112 is inserted into the sleeve 116.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the disclosed, exemplary embodiment.

What is claimed is:

1. A surface supported lighting media, comprising:
a chemiluminescent element; and
a reusable support element, the support element configured for insertion into the surface in a desired orientation, the support element including a surface insertion spike and a stick receiving portion, wherein the chemiluminescent element and the support element releasably engage one another to support the chemiluminescent element in a desired orientation when the support element is inserted into the surface, and wherein the chemiluminescent element can be disengaged from the support element for replacing the chemiluminescent element.

2. The surface supported lighting media in accordance with claim 1 wherein the chemiluminescent element includes an annular sleeve and the support element includes an insert portion configured for receipt in the sleeve.

3. The surface supported lighting media in accordance with claim 1 wherein the support element includes an enlarged contact region at a location at which the chemiluminescent element and the support element engage one another.

4. The surface supported lighting media in accordance with claim 3 wherein the contact region is a flange.

5. The surface supported lighting media in accordance with claim 1 wherein the support element includes a sleeve-like receiving element configured for receiving the chemiluminescent element.

6. The surface supported lighting media in accordance with claim 5 wherein the support element includes a contact region within the sleeve-like receiving element to provide a location at which the chemiluminescent element and the support element engage one another.

7. The surface supported lighting media in accordance with claim 6 wherein the support element includes a retaining element to releasably secure the chemiluminescent element in the sleeve-like element.
